(19) United States
(12) Patent Application Publication
(10) Pub. No.: US 2010/0272935 A1
(43) Pub. Date: Oct. 28, 2010

(54) MODULAR-STRUCTURE DRUM FOR ELECTRICAL AND HOUSEHOLD SERVICES

(75) Inventors: Klaus Müller, Sulzbach (DE); Klaus Klemm, Oberelsbach (DE)

Correspondence Address: LyondellBasell Industries, 3801 WEST CHESTER PIKE, NEWTOWN SQUARE, PA, 19073, US

(73) Assignee: Basell Poliolefine Italia S.r.l., Milano (IT)

(21) Appl. No.: 12/734,732

(22) PCT Filed: Nov. 27, 2008
(86) PCT No.: PCT/EP2008/010078

§ 371 Date: May 19, 2010

Related U.S. Application Data
(60) Provisional application No. 61/010,536, filed on Jan. 9, 2008.

(30) Foreign Application Priority Data
Nov. 28, 2007 (DE) 10 2007 057 606.6

(51) Int. Cl. D06F 37/02; B32B 1/08; B29C 53/36

(52) U.S. Cl. 428/34.7; 428/35.7; 428/35.6; 156/218

(57) ABSTRACT

The present invention relates to a modular-design drum composed of a plurality of geometrically differently or equally shaped individual components, which are first fabricated as separate parts from a thermoplastic polymer and thereafter the components are assembled to the drum, wherein at least one of the components is at least partly laminated with an intermediate layer and a decorative layer, with an intermediate layer and a heat-cured outer layer or with an intermediate layer, a decorative layer and a heat-cured outer layer and to processes for the production of the modular-design drum, and to its use as inner part of tumbler dryers, washing machines, or spin-dryers.

The present invention relates to a novel, specifically modular-design drum which can be used particularly advantageously as inner part for electrical and household devices, in particular those devices which serve for treatment of laundry. According to the invention, the modular-design drum is composed of a plurality of geometrically differently or equally shaped individual components, which are first fabricated as separate parts from a thermoplastic polymer and thereafter assembled to give the drum. At least one of the components is at least partly laminated with an intermediate layer and a decorative layer, with an intermediate layer and a heat-cured outer layer or with an intermediate layer, a decorative layer and a heat-cured outer layer.

The invention further relates to processes for the production of the modular-design drum, and to its use as inner part of tumbler dryers, washing machines, or spin-dryers.

Rotating drums conventional hitherto used for electrical and household devices, for example in tumbler dryers, are composed of stainless sheet metal, so that they can dependably resist the severe stress generated by ambient conditions which are corrosive in the widest sense, examples being high temperature, high moisture level, high humidity, etc., for the lifetime demanded from the device.

EP 1 420 103 A2 describes the structure of a modular-structure laundry dryer drum, where individual metal parts usually used, such as front wall, rear wall, and cylindrical drum body, are interlock-bonded to one another. “Laundry lifters” composed of plastic are then inserted into this drum, and give the laundry a swirling motion during the treatment procedure. However, washer drums completely manufactured from plastic have not hitherto achieved any established status for practical purposes, because the stringent requirements placed upon the drum body with respect to its stiffness under adverse temperature conditions do not permit cost-effective manufacture of inner drums from plastic for commercially available devices.

It was an object of the present invention to propose a modular structure for a drum which can be used as rotating drum and combines firstly good stability and secondly cost advantages during manufacture, and also the possibility of recycling.

The object in particular consisted in retaining the available technical possibilities, encompassing simple processing methods and low-cost manufacture of individual parts, while providing a drum as internal part for electrical devices, such as tumbler dryers, washing machines, or spin-dryers, which is essentially composed of thermoplastic, preferably of polypropylene. Specifically, this type of design is likely to provide particular advantages in relation to raw materials costs (by replacing stainless steel with plastic); capital expenditure (since working sheet metal is replaced by manufacturing plastics parts which could also be transferred to sub-suppliers); easier changeover between models; and sound-deadening (since plastic is superior to metal in solids-borne sound-deadening).

This object is achieved via a modular-design drum composed of a plurality of geometrically differently or equally shaped individual components, which are first fabricated as separate parts from a thermoplastic polymer and thereafter the components are assembled to the drum, wherein at least one of the components is at least partly laminated with an intermediate layer and a decorative layer, with an intermediate layer and a heat-cured outer layer or with an intermediate layer, a decorative layer and a heat-cured outer layer.

For the purposes of the present invention, the “modular-design” feature is intended to mean that, by analogy with the known structure of modular-structure drums for electrical and household devices composed of a front wall with opening, of a body drum section composed of a plurality of segments and of lifters, and of a rear wall, according to the invention any desired combination of these individual parts or modules of the drum can be realized, these being produced in each case as individual components which are thereafter easily assembled to give the finished drum.

Surprisingly, use of the components, which are at least partly laminated with an intermediate layer and a decorative layer, with an intermediate layer and a heat-cured outer layer or with an intermediate layer, a decorative layer and a heat-cured outer layer, permits realization of a drum as inner part for electrical and household devices for laundry treatment, whose structure is completely based on thermoplastic polymer, and which nevertheless has sufficient stiffness to withstand dependably the particular adverse mechanical and thermal conditions to which the drum has exposure during its correct use.

The inventive structure of the drum permits for the first time combination of the characteristic properties of thermoplastic raw materials, in particular their easy processing via extrusion, injection molding or other forming processes, and their capability for recycling, with resultant low part price, with a surface which is functional with regard to good resistance to adverse temperature conditions and to chemicals, and advantageous abrasion performance. The possibility of decoration (color, pattern) of the finished part by way of an appropriate multilayer laminate structure is yet another added possibility.

It has been found that the stiffness of a plastics specimen can be markedly improved via lamination with a decorative layer or a heat-cured layer. This can achieve a stiffness level which has not hitherto been achievable via pure plastics solutions for drums. This particularly applies to the case where the drums have exposure to relatively high temperatures. Here, inventive modular structure with the individual components composed of composite material leads to clear advantages.

It has also been found that a bilateral embodiment with bilaterally arranged intermediate layers and decorative layers and/or heat-cured layers should be used with preference, because the bilateral embodiment has not only the greatest gains in strength but also the lowest tendency toward warpage.

The properties of the inventive, modular-design drum can be varied within a particularly wide range by way of targeted modification of the thermoplastic polymer, which can be impact-modified, provided with mineral fillers, or glass fiber-reinforced, and mechanical properties here can thus be matched to the requirements placed upon the drum, without any negative effects on the surface properties and the surface quality of the drum.

The features and advantages of the present invention can be better understood via the following description and the accompanying drawings.

FIG. 1 shows a drum composed of a front wall (1), a cylindrical drum body (2), a rear wall (3) with a ring of perforations, and laundry lifters (4). Dotted arrows (5) indicate how the components are combined. For simplification reasons a showing of fixation of the drum and of drum axes was omitted.

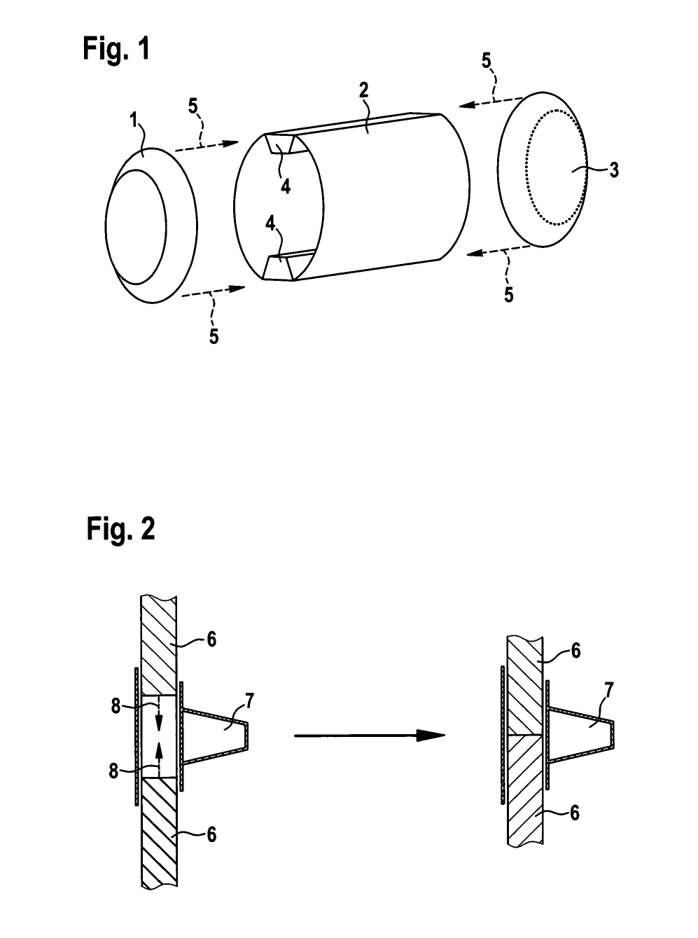

FIG. 2 illustrates bonding of the butt ends (6) of components being part of the drum body by a plastics profile (7) which is shaped in form of a lifter. The picture on the left-hand side displays the situation before the installation procedure with dotted arrows (8) indicating the motion direction of the butt ends (6) while the picture on the right-hand side shows the bonding process after the ends have been joined together.

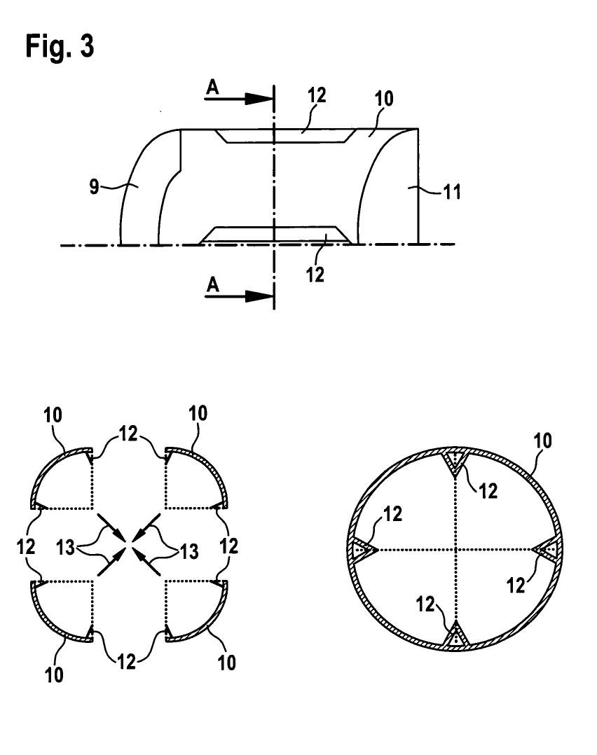

FIG. 3 illustrates a cylindrical drum composed of four equally shaped components, which all comprise segments (9) for forming the front wall with opening, segments (10) for forming the drum body, segments (11) for forming the rear wall and segments (12) for forming the laundry lifter. The upper illustration shows one of the components. The picture at the bottom on the left-hand side displays a cross-section in plane A-A before assembling the drum with arrows (13) indicating how the components are combined. The picture at the bottom on the right-hand side shows a cross-section in plane A-A of the assembled drum.

The components of the present invention are fabricated from a thermoplastic polymer. In preferred embodiments of the invention the thermoplastic polymer is polypropylene (PP), polyethylene (PE), polybutene-1 (PB-1), polyvinyl chloride (PVC), polysulfones, polyetherketones, polyesters, such as polyethylene terephthalate (PET), polybutylene terephthalate (PBT) or polyalkylene naphthalate, polycycloolefins, polyacrylates, polymethacrylates, such as polymethylmethacrylate (PMMA), polyamides (PA), such as poly-epsilon-caprolactam or polyhexamethyleneadipamide or polyhexamethylene sebacamide, polycarbonate (PC), polyurethanes, polyacetals, such as polyoxymethylene (POM), polystyrene (PS), acrylonitrile/butadiene/styrol copolymer (ABS), liquid crystal polymer (LCP), e.g. liquid crystal copolyester, or polyphenylene sulfide (PPS). It is also possible to use mixtures of such thermoplastic polymers as plastic material of the present invention.

Homopolymers and copolymers are in principle suitable as thermoplastic polymers. Copolymers of propylene and ethylene or of ethylene or propylene and other olefins having 4 to 10 carbon atoms, or co- or terpolymers of styrene and smaller proportions of butadiene, alpha-methylstyrene, acrylonitrile, vinylcarbazole or esters of acrylic or methacrylic or itaconic acid are particularly worthy of mention in the context. The thermoplastic polymers may, in order to improve cost-effectiveness of its production, also comprise recycled materials from the polymers mentioned, in amounts of up to 60% by weight, based on the total weight of the thermoplastic polymer.

According to the invention, the term polyoxymethylene (POM) is understood as meaning homopolymers as well as copolymers of aldehydes, such as formaldehyde or acetaldehyde, but preferably of cyclic acetals. For POM, it is characteristic that repeating carbon-oxygen bonds always typify the appearance of the molecular chain. If polyester is to be used for the present invention, polyethylene terephthalate (PET) or polybutylene terephthalate (PBT) are preferred. Both are high-molecular-weight esterification products of terephthalic acid and, respectively, ethylene glycol and butylene glycol. Suitable copolymers of styrene are in particular copolymers comprising up to 45% by weight, preferably comprising up to 20% by weight, of acrylonitrile incorporated in the form of polymerized units. Further terpolymers of styrene comprise up to 35% by weight, in particular up to 20% by weight, of acrylonitrile incorporated in the form of polymerized units and up to 35% by weight, preferably up to 30% by weight, of butadiene.

Preferably the thermoplastic polymer is a polyolefin, such as polyethylene, polypropylene or polybutene-1, of which polypropylene is particularly preferred. According to the invention, polypropylene is understood as meaning homopolymers as well as copolymers of propylene. Suitable copolymers of propylene comprise up to 50% by weight of further monomers copolymerizable with propylene, such as 1-olefins having 2 or 4 to 8 carbon atoms. If required, two or more comonomers may also be used. Suitable copolymers are preferably random copolymers but may also be block copolymers.

The polymerization for the preparation of polypropylene can usually be effected under a pressure in the range from 1 to 100 bar (from 0.1 to 10 MPa) in suspension or in the gas phase and in the presence of a Ziegler-Natta catalyst system. Those catalyst systems which, in addition to a titanium-containing solid component, also comprise cocatalysts in the form of organic aluminum compounds and electron donor compounds are preferred.

Ziegler-Natta catalyst systems comprise as a rule a titanium-containing solid component, in particular halides or alcoholates of trivalent or tetravalent titanium, and also a halogen-containing magnesium compound, inorganic oxides, such as silica gel, as support material and electron donor compounds. In particular, carboxylic acid derivatives or ketones, ethers, alcohols or organosilicon compounds may be mentioned as electron donor compounds.

The titanium-containing solid component can be prepared by known processes for example as described in EP 0 761 696 A1.

Cocatalysts suitable for the Ziegler-Natta catalyst systems are, in addition to trialkylaluminium, also those compounds in which an alkyl group is replaced by an alkoxy group or by a halogen atom, such as chlorine or bromine. The alkyl groups may be identical or different. Linear or branched alkyl groups are also suitable. Trialkylaluminium compounds whose alkyl groups comprise 1 to 8 carbon atoms, for example triethylaluminium, triisobutylaluminium, trioctylaluminium or methyl-diethylaluminium or mixtures thereof, are preferably used according to the invention.

The preparation of polypropylene can however also be effected in the presence of a metallocene as a catalyst. Metallocenes are to be understood as meaning complex compounds having a layer structure and comprising metals from the subgroups of the Periodic Table of the Elements plus organic, preferably aromatic, ligands. For their use for the preparation of polypropylene, the metallocene complexes are expediently applied to a support material. The inorganic oxides which are used for the preparation of the titanium-containing solid component in Ziegler-Natta catalysts have also proven to be useful as support material.

Metallocenes usually used comprise, as a central atom, titanium, zirconium or hafnium, of which zirconium is preferred. The central atom is linked via a pi bond to at least one pi system which is embodied by a cyclopentadienyl group. The cyclopentadienyl group is equipped in the vast majority of cases with additional substituents, by means of which the activity of the catalyst can be controlled. Preferred metallocenes comprise central atoms which are bonded via two identical or different pi bonds to two pi systems which may simultaneously also be part of corresponding heteroaromatic systems.

In principle, any compound, which can convert the neutral metallocene into a cation and can stabilize it, is suitable as a cocatalyst for the metallocene. In addition, the cocatalyst or the anion formed from it should not undergo any further reactions with the metallocenium cation formed, which is stated in EP 0 427 697. The preferably used cocatalyst is an aluminium compound and/or a boron compound. A preferably used cocatalyst is an aluminium compound, such as alumoxane and/or an alkylaluminium.

The thermoplastic polymers may further comprise from 1 to 80% by weight, preferably from 5 to 50% by weight, particularly preferably from 10 to 40% by weight, of reinforcing fillers. Examples are barium sulfate, magnetite, ferrosilicon, magnesium hydroxide, talc whose average particle size is in the range from 0.1 to 100 μm, measured according to DIN 66115, wood, flax, chalk, glass beads, or coated or non-coated, short or long glass fibers, or mixtures of these. In addition, the thermoplastic polymers may comprise further additives, such as light stabilizers, UV stabilizers and heat stabilizers, pigments, carbon blacks, lubricants and processing aids, flame retardants, blowing agents and the like, in respectively advantageous amounts.

In preferred embodiments the thermoplastic polymer is a polypropylene comprising reinforcing fillers. Especially preferred fillers are talc or glass fibers and particularly short glass fibers. Suitable polypropylenes are for example polypropylene copolymers reinforced with from 10 to 40% by weight of talc having a MFR in the range of from 1 to 20 g/10 min, measured to DIN EN ISO 1133:2005 at a temperature of 230° C. and under a load of 2.16 kg and being composed of from 90 to 98 mol % of propylene, from 2 to 10 mol % of ethylene and optionally further 1-olefins having from 4 to 8 carbon atoms. Suitable for preparing the drums of the present invention are furthermore polypropylenes reinforced with glass fibers, and particularly with short glass fibers, having a MFR in the range of from 10 to 200 g/10 min, preferably from 20 to 100 g/10 min and especially from 30 to 70 g/10 min, measured to DIN EN ISO 1133:2005 at a temperature of 230° C. and under a load of 2.16 kg. Such polypropylenes can be homopolymers or copolymers, however homopolymers are preferred. The content of glass fibers is usually in the range of from 10 to 40% by weight. Preferably the glass fibers are chemically coupled to the polypropylene matrix.

At least one of the components of the modular-design drum is at least partly laminated with an intermediate layer and a decorative layer and/or a heat-cured outer layer. Such laminated structures are known in the art and are for example described in EP 1 060 877 A2 or EP 1 126 069 A2. In case the component of the modular-design drum has such a laminated structure, the thermoplastic polymer forms the support layer. It can take the form of injection-molded, extruded, or compression-molded sheet of various thicknesses and sizes. Preferred layer thicknesses for the support layer are in the range from 0.5 to 20 mm, particularly from 2 to 15 mm.

The intermediate, decorative and/or heat-cured outer layers are at least arranged on one, but preferably on both surfaces of the support layer.

The intermediate layer is usually made from a thermoplastic, preferably from the thermoplastic also used as component of the support layer. The intermediate layer is in particular a thin film or else a thin nonwoven of a thickness from 0.001 to 1.0 mm, in particular from 0.005 to 0.3 mm. Another possibility for an intermediate layer is a resin-saturated nonwoven or a resin-saturated film made from a thermoplastic. Resins used for this are in particular acrylate resins, phenolic resins, urea resins or melamine resins. The degree of saturation with resin here can be up to 300%, and this means that practically the entire surface of the intermediate layer has complete resin saturation, the weight of the resin then amounting to 300% of the weight of the intermediate layer without resin. The degree of saturation with resin is preferably from 15 to 150%, particularly preferably from 80 to 120%. By virtue of these combinations it is possible to produce a particularly secure adhesive bond between the support layer and the intermediate layer. According to the invention, the weight of the intermediate layer is in the range from 15 to 150 g/m², preferably from 30 to 70 g/m².

In a preferred embodiment, especially if the thermoplastic polymer of the support layer is a polypropylene, the thermoplastic material used for the intermediate layer comprises a polypropylene prepared in the presence of a metallocene as catalyst, wherein preference is given to such a polypropylene prepared in the presence of a metallocene which has a melt flow index MFR in the range from 10 to 60 g/10 min, measured to DIN EN ISO 1133:2005 at a temperature of 230° C. and under a load of 2.16 kg.

According to the invention, the decorative layer, if present, is arranged on the intermediate layer.

The decorative layer can be composed of a plastics material which has an embossment or a coloration or both combined, or may be a pre-finished laminate. The decorative layer can also be composed of paper or of a fabric or of metal or of a paper-like or fabric-like or metal-like or wood-like material. The decorative layer may also have been resinified with acrylic resins, phenolic resins, urea resins or melamine resins. In a preferred embodiment the decorative layer is composed of a metal, for example being an aluminum or steel foil. A decorative layer made of metal is usually not covered by a heat-cured layer, but forms by itself the outer surface or is covered by a protecting lacquer or coating, for example based on alkyd resin, acrylic resin or polyurethane, applied as one-component or two-component system.

The heat-cured layer arranged upon the decorative layer, or upon the intermediate layer if no decorative layer is present, is preferably composed of a thermoset plastic, for example of a paper saturated with acrylic resin, with phenolic resin, with melamine resin or with urea resin, crosslinked by exposure to pressure or heat during the production of the layered composite material. The weight of the heat-cured layer is normally in the range of from 15 to 150 g/m², preferably of from 20 to 70 g/m².

The drum is composed of at least two components, preferably of from 3 to 8 components. The components can have different shapes. It is also possible that some or all of the components have the same shape. The whole surface of one component can be unitary. It is however also possible that one component combines different types of surfaces. The drum may comprise individual components which can differ functionally and in their appearance and which can be combined advantageously with one another.

The components can be bonded to each other in an air-tight manner, thus ensuring that the components are bonded to one another with no gaps, so as to avoid any damage to the laundry and minimize leakage flow. This is preferably achieved by bonding by way of a welding procedure. Other bonding technologies are also conceivable, but welding of the individual parts to one another is preferred in the invention, because the welding process produces an air-tight drum, which is especially desirable for drums used in tumbler dryers.

If it is not necessary to have an air-tight or liquid-tight joint between the components the coupling of the component with each other can also occur via snap-action connection. This simplifies the assembling process drastically and is accordingly more economic, and moreover allows easily combining components made of different thermoplastic polymers, for example for specifically tailoring the properties of different components of the drum.

In a preferred embodiment the cylindrical drum body, the front wall and/or the rear wall have perforations, which, for example, can optimize air flow.

Preferably the drum is of rotational symmetry.

The drum can be constructed analogously to existing types of drums made of metals as can be seen in FIG. 1. Preferably all parts of such a drum, front wall with opening (1), cylindrical drum body (2), rear wall (3), and laundry lifters (4), are fabricated from the same thermoplastic polymer.

The cylindrical drum body (2) can be fabricated as one component. Preferably the cylindrical drum body (2) is however composed of more than one component. In preferred embodiments from 2 to 6 components, and especially 4 components give the cylindrical drum body (2).

The components forming the cylindrical drum body (2) are usually bonded to one another with no gaps, so as to avoid any damage to the laundry and minimize leakage flow. This is achieved either via welding of the butt ends of the parts of the drum body, for example, by way of a heating tool, or by using a jointing profile composed of metal or plastic or by using a combination of the two methods. If a bonding profile composed of plastic is used, additional welding of sheet and profile is also possible.

The idea of bonding by using a profile section can moreover be used in order to bond this to lifters which are needed for the functioning of the drum in a dryer. The invention thus can produce the cylindrical drum body (2) at low cost without additional components.

If the welding method is selected for the installation process, it can then be advantageous to weld the lifters (4) to the surface of the components forming the cylindrical drum body (2) before these components are welded to give a closed cylinder.

FIG. 2 shows how the lifters can be designed as plastics profile (7) for bonding of the butt ends (6) of components being part of the drum body. The plastics profile (7) is formed in a way that a part of it functions as laundry lifter. It is thus possible to omit any welding procedure during installation of the components being part of the drum body with the lifters. However, it is, of course, possible nevertheless to carry out a welding process in the event that this is deemed advisable.

The number of lifters or components being part of the drum body to be used can be selected freely. Two lifters are usually combined with two components, but it is also fully possible to combine three or four lifters with three or four components being part of the drum body.

In order to improve the rotational properties of the entire system, the lifters designed as plastics profiles can be designed with a radius corresponding to the radius of the drum.

It is preferable for both the lifter and the components being part of the drum body to be composed of the same type of thermoplastic polymer.

The cylindrical drum body (2), usually composed of more than one component, is then welded to the front wall (1) and rear wall (3) parts, which are separately produced, preferably by injection molding. Heated tool welding can likewise be used for this purpose. However, by virtue of the rotational symmetry of the parts, it is also possible to use spin welding methods to bond the parts.

In a preferred embodiment of the invention all components of the drum are equally shaped. That means, each component does not only provide a part of the cylindrical drum body but also a part of the front wall, a part of the rear wall, and a part of the lifter. FIG. 3 illustrates a cylindrical drum composed of four equally shaped components, which all comprise segments (9) for forming the front wall with opening, segments (10) for forming the drum body, segments (11) for forming the rear wall and segments (12) for forming the laundry lifters. By assembling the four components a drum with a front wall with opening, a rear wall, and laundry lifters is obtained.

Since assembled segments (11) act as laundry lifter no production of a separate lifter is required. That can give a reduction in factory production costs. The number of equally shaped components to produce the drum can be selected freely. In order to avoid any unnecessary increase in the difficulty of demolding in the injection molding process for producing the components, at least three, or more preferably four, components should be combined, but five or more components are also suitable.

In one embodiment of the present invention the segments of the components forming the cylindrical drum body are profiled longitudinally, preferably having a corrugated profile. Longitudinal profiling increases the flexural strength of the drum body along the longitudinal axis, and this design can (as a function of the shape of the profiling) be used for relatively high mechanical loads, or, if appropriate, wall thickness can be reduced, or a material with lower stiffness can be used, when comparison is made with drum bodies without such a profile.

At least one of the components of the drum is at least partly laminated with an intermediate layer and a decorative layer and/or a heat-cured outer layer. Preferably the inner surface of the drum is laminated, resulting in an improved wear resistance. This lamination preferably covers the whole inner surface. Use of a laminate with a metal foil as decorative layer, which is especially preferred, creates an additional metallic appearance, i.e. an appearance of the inner drum perceived by the end user as having higher quality, and can avoid static charging by way of appropriate grounding of the inner side.

Moreover, lamination on the inner surface of the drum or on the outer surface of the drum or on both surfaces with layers securely bonded to the thermoplastic polymer considerably increases the longitudinal flexural stiffness of the drum. In a preferred embodiment both surfaces of the drum are at least partly laminated with an intermediate layer and a decorative layer and/or a heat-cured outer layer.

The lamination on the outer surface of the drum may cover the whole surface or only part of it. It is also possible that only part of the outer surface is laminated, preferably with a lamellar structure with stripes running from the rear wall of the drum to the front wall, i.e. longitudinally in the direction of the longitudinal axis of the drum. Such a lamellar structure improves flexural stiffness along the longitudinal axis similarly to a lamination on the whole surface, however allows much easier deformation for the bending procedure in the circumferential direction, for example if planar segments are produce via an extrusion process and thereafter bended to the cylindrical form. Moreover, a lamination with lamellar structure allows an effective improvement of flexural stiffness along the longitudinal axis with reduced usage of lamination materials and therefore reduced material costs. Furthermore, a lamination on the outermost area of the outer surface of the drum might also bring some emergency running properties to rotating drums if in case of overloading the deflection of the drum becomes so high that there is a risk that the drum touches the container wall. A suitable lamination provides lower friction and drastically reduces the risk that drum and container are unintentionally welded together, especially if both are produced from the same thermoplastic polymer. Preferably, the outer surface of the drum body is laminated with an intermediate layer, a heat-cured outer layer and optionally a decorative layer in-between the intermediate layer and the heat-cured outer layer.

The present invention further provides processes for the production of a drum.

In a preferred embodiment the components being part of the drum body are first produced, preferably flat, through an extrusion process, optionally with subsequent lamination, and thereafter curved to the cylindrical shape of the drum body. The structure of the applied laminate has to have been selected so as to retain its integrity exposed to the bending stress. Specifically, two fundamentally different properties have to be achieved in the composite. For reasons of strength, minimum deflection of the main curved section of the drum along the longitudinal axis of the drum is desired, but the intention is to minimize the work required (low costs) for the bending procedure in the circumferential direction. Numerous experiments surprisingly showed that the best results, specifically high longitudinal stiffness together with low circumferential bending force, can be achieved if the starting material for the laminate composite comprises a comparatively soft thermoplastic polymer which is for examples a polypropylene produced by Basell in a process known as CATALLOY® process, and providing this starting material, on the outer side of the drum, with a stabilizing system of longitudinally oriented strips.

The thickness of the extruded sheet is a function of the strength demanded. However, it will not be less than a minimum of 0.5 mm. The lateral sheet ends are then either welded longitudinally to one another, for example, by way of a heating tool, or bonded to one another by way of a bonding profile composed of metal or plastic. If a bonding profile composed of thermoplastic polymer is used, additional welding of sheet and profile is also possible. Thereafter the lifters are installed. This can be achieved by way of a plug connection or else by way of welding of the individual parts to one another. It is preferable for both the lifter and the components forming the cylindrical drum body to be composed of the same type of thermoplastic polymer.

If the welding method is selected for the installation process, it can then be advantageous to weld the lifters to the surface of the components forming the drum body before these components are welded by way of the lateral sheet ends or are bonded by way of a plug-fit profile to give a closed cylinder. The drum body is then welded to the front wall and rear wall parts, preferably separately produced by injection molding.

If the components forming the drum body have perforations, these can, for example, be applied during a stamping procedure downstream of the extrusion process, or be applied during the bending process.

It is also possible to produce the components forming the drum body by means of injection molding, in particular back injection molding of inserted films or foils, especially if the inventive drum is produced by joining a plurality of individual segments together, these being produced individually in advance. In this variant, a drum body component can be produced which at this stage has a curvature, thus rendering superfluous any additional downstream bending procedure. Possible integration of the lifters is not affected by the downstream procedure of joining the individual segments together. It is also possible to produce more than one of the components at the same time, which means in one machine cycle, by using multi-cavity molds.

The invention also provides a process for the production of the inventive composite material by the back injection molding technique. In order to produce a secure adhesive bond from the thermoplastic polymer which acts as support layer, and the intermediate layer and the decorative layer and/or the heat-cured layer, the back injection molding technique uses the material for the heat-cured layer and/or the decorative layer, and the intermediate layer of one of the sides as initial charge for one half of the injection mold and, where desired, uses the material for the heat-cured layer and/or the decorative layer, and the intermediate layer of the other side as initial charge for the other half of the injection mold. The material for the intermediate layer, the decorative layer, and/or the heat-cured layer is normally inserted into the mold in the form of sheet-like structures. Once the mold has been closed, the thermoplastic polymer is injected at a temperature in the range of from 150 to 330° C. and under a pressure of from 5 to 2500 bar (=from 0.5 to 250 MPa) into the cavity below the intermediate layer or between the bilateral intermediate layers. The mold temperature is generally from 8 to 160° C. on both sides. Once the thermoplastic polymer has been injected under the stated conditions, the mold is cooled to ambient temperature. The cooling time for this is in the range from 0.01 to 5.0 min.

The procedure followed for compression molding is in principle the same. The only difference is that the thermoplastic in pellet form is introduced below, between, or on top of the individual foils inserted in the layer sequence, and is subjected to a pressure of at least 5 bar (=0.5 MPa) and to a bilateral press temperature of at least 100° C., and a compression time of at least 30 sec.

The same method has proven extremely successful in injection-compression molding and transfer molding.

The drum of the present invention are suited for use of as inner part of a tumbler dryer, a washing machine or a spin-dryer or for any other use where drum-shaped article can advantageously be applied. They are especially suited for use of as inner part of a tumbler dryer. They are further especially suited for use of as washer drum in washing machines, if glass fiber-reinforced polypropylene is used as material for the components.

1. A modular-design drum comprising a plurality of geometrically differently or equally shaped individual components, which are first fabricated as separate parts from a thermoplastic polymer and thereafter the components are assembled to the drum, wherein at least one of the components is at least partly laminated with an intermediate layer and a decorative layer, with an intermediate layer and a heat-cured outer layer or with an intermediate layer, a decorative layer and a heat-cured outer layer.

2. The drum as claimed in claim 1, wherein the thermoplastic polymer for fabricating the individual components is selected from the group consisting of polypropylene (PP), polyethylene (PE), polybutene-1 (PB-1), polyvinylchloride (PVC), polysuiphones, polyether ketones, polyesters, polycycloolefins, polyacrylates, polymethacrylates, polyamides (PA), polycarbonate (PC), polyurethanes, polyacetals, polystyrene (PS), acrylonitrile/butadiene/styrol copolymer (ABS), liquid crystal polymer (LCP), and polyphenylene sulphide (PPS), and mixtures of these.

3. The drum as claimed in claim 1, wherein the thermoplastic polymer comprises an amount of from 1 to 80% by weight of reinforcing fillers.

4. The drum as claimed in claim 3, wherein the reinforcing fillers are barium sulfate, magnetite, ferrosilicon, magnesium hydroxide, talc whose average particle size is in the range from 0.1 to 100 μm, measured to DIN 66 115, wood, flax, chalk, or glass beads, coated or non-coated, short or long glass fibers, or a mixture of these.

5. The drum as claimed in claim 1, wherein the individual components are all fabricated from the same thermoplastic polymer.

6. The drum as claimed in claim 1, wherein the whole inner surface of the drum is laminated with an intermediate layer, a decorative layer and optionally a heat-cured outer layer or a protecting lacquer or coating, wherein the decorative layer is a metal foil.

7. The drum as claimed in claim 1, wherein the whole outer surface of the drum body or part of the outer surface of the drum body is laminated with an intermediate layer, a heat-cured outer layer and optionally a decorative layer in-between the intermediate layer and the heat-cured outer layer.

8. The drum as claimed in claim 1, wherein each component of the drum is equally shaped.

9. A process for the production of a drum as claimed in claim 1, wherein first the components forming the drum body are produced through an extrusion process and thereafter curved to the cylindrical shape of the drum body and the front wall and the rear wall components are produced by injection molding and then the ends of the components are bonded to one another.

10. A process for the production of a drum as claimed in claim 1, wherein first the components forming the drum are produced by means of injection molding, and then the ends of the components are bonded to one another.

11. A process for the production of a drum as claimed in claim 10, in which the material for the intermediate layer and the decorative layer, the intermediate layer and the heat-cured outer layer or the intermediate layer, the decorative layer and the heat-cured outer layer, in each case in the form of sheet-like structures, is first inserted in the mold, and is then bonded with the thermoplastic polymer for the support layer, by back injection molding.

12. The use of a drum as claimed in claim 1 as inner part of a washing machine, a tumbler dryer, or a spin-dryer.
